(19) United States
(12) Patent Application Publication
(10) Pub. No.: US 2026/0052606 A1
(43) Pub. Date: Feb. 19, 2026

(54) MONOLITHIC LAYERED HEATER FOR THIN-WALLED SUBSTRATES

(71) Applicant: WATLOW ELECTRIC MANUFACTURING COMPANY, ST. LOUIS, MO (US)

(72) Inventor: Martin WALLINGER, Abtenau (AT)

(73) Assignee: WATLOW ELECTRIC MANUFACTURING COMPANY, ST. LOUIS, MO (US)

(21) Appl. No.: 19/368,274

(22) Filed: Oct. 24, 2025

Related U.S. Application Data
(63) Continuation of application No. PCT/US2024/026022, filed on Apr. 24, 2024.
(60) Provisional application No. 63/461,457, filed on Apr. 24, 2023.

(51) Int. Cl. H05B 3/18

(52) U.S. Cl. CPC H05B 3/18; H05B 2203/013; H05B 2203/016; H05B 2203/017

(57) ABSTRACT

A monolithic heated 3D body includes a thin-walled substrate defining a complex curved exterior surface, and a layered heater applied to the complex curved exterior surface of the thin-walled substrate. The layered heater includes at least one resistive heating layer, a set of termination pads in electrical contact with the at least one resistive heating layer, and a dielectric layer disposed over the at least one resistive heating layer.

### CROSS-REFERENCE TO RELATED APPLICATIONS

This application is a continuation of International Application No. PCT/US2024/026022, filed on Apr. 24, 2024, which claims priority to U.S. provisional application No. 63/461,457 filed on Apr. 24, 2023. The disclosures of the above applications are incorporated herein by their reference.

### FIELD

The present disclosure relates to electric heaters, and more specifically to electric heaters formed by a layered process such as thermal spraying.

### BACKGROUND

The statements in this section merely provide background information related to the present disclosure and may not constitute prior art.

A variety of heating applications include a substrate to be heated, which can define a variety of geometries, some of which are complex and thus difficult to attach a heater. Further, some substrates are extremely thin/flexible, which also creates installation challenges for electric heaters. In some applications, these substrates are heated to relatively high temperatures, greater than 250°C. (482°F.), which limits the materials that can be used for the heater and for the mounting hardware.

These challenges related to thin, complex shaped substrates that are heated to relatively high temperatures are addressed by the present disclosure.

### SUMMARY

This section provides a general summary of the disclosure and is not a comprehensive disclosure of its full scope or all of its features.

In one form of the present disclosure, a monolithic heated 3D body comprises a thin-walled substrate defining a complex curved exterior surface and a layered heater applied to the complex curved exterior surface of the thin-walled substrate. The layered heater comprises at least one resistive heating layer, a set of termination pads in electrical contact with the at least one resistive heating layer, and a dielectric layer disposed over the at least one resistive heating layer.

In variations of this monolithic heated 3D body, which may be implemented individually or in any combination: a base dielectric layer is applied onto the complex curved exterior surface of the thin-walled substrate, wherein the at least one resistive heating layer is applied onto the base dielectric layer; the layered heater is formed by a layered process; the thin-walled substrate has a thickness between about 0.2 mm and about 10.0 mm; the at least one resistive heating layer is continuous across the complex curved exterior surface of the thin-walled substrate; the at least one resistive heating layer is patterned across the complex curved exterior surface of the thin-walled substrate; the set of termination pads are on a common layer; the set of termination pads are on different layers; the thin-walled substrate is a tin material; the thin-walled substrate that has a thickness limited to no more than one order of magnitude thicker than each of the at least one resistive heating layer and the dielectric layer; the thickness of the thin-walled substrate is between about 0.2 mm to about 10 mm, and the thickness of each of the at least one resistive heating layer and the dielectric layer of the layered heater is between about 0.01 mm to about 0.25 mm; the complex curved exterior surface is one of a Bézier surface, a B-spline surface, or a non-uniform rational basis (NURB) surface; the layered heater is applied to the complex curved exterior surface of the thin-walled substrate with a thermal spray process; the at least one resistive heating layer is patterned using a laser removal process; and the set of termination pads are in a form of strips.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic side cross-sectional view of a heater constructed according to the teachings of the present disclosure;

FIG. 2A is a perspective view of a Bézier surface, to which the teachings of the present disclosure may be applied;

FIG. 2B is a perspective view of a B-spline surface, to which the teachings of the present disclosure may be applied;

FIG. 2C is a perspective view of a non-uniform rational basis (NURB) surface, to which the teachings of the present disclosure may be applied;

FIG. 3A is a schematic side cross-sectional view of a layered heater constructed according to the teachings of the present disclosure;

FIG. 3B is a top view of the layered heater of FIG. 3A;

FIG. 4A is a schematic side cross-sectional view of another layered heater constructed according to the teachings of the present disclosure;

FIG. 4B is a top view of the layered heater of FIG. 4A;

FIG. 5A is a schematic side cross-sectional view of yet another layered heater constructed according to the teachings of the present disclosure; and

FIG. 5B is a top view of the layered heater of FIG. 5A.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

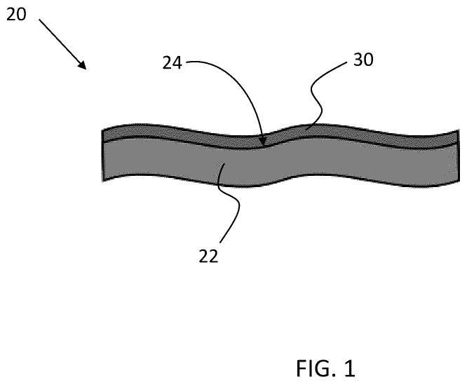

Referring to FIG. 1, a monolithic heated 3D body is illustrated and generally indicated by reference numeral 20. The monolithic heated 3D body 20 generally comprises a thin-walled substrate 22 defining a complex curved exterior surface 24. A layered heater 30 is applied to the complex curved exterior surface 24 of the thin-walled substrate 22, and the layered heater 30 provides the requisite heat to the thin-walled substrate 22 as set forth in greater detail below. As used herein, the term “layered heater” should be construed to mean a heater that comprises at least one functional layer (e.g., resistive heating layer, dielectric layer, RF shielding layer, among others), wherein each layer is formed through application or accumulation of material to a substrate or another layer using processes associated with thick film, thin film, thermal spray, or sol-gel, among others. These processes are also referred to as “layered processes” or “layered heater processes.” As set forth in greater detail below, these layered processes impart distinctive structural characteristics to the monolithic heated 3D body 20 compared with conventional heater constructions such as those having discrete resistive wires.

As used herein, the term “thin-walled” should be construed to mean a substrate that has a thickness limited to no more than one (1) order of magnitude thicker than each of the functional layers of the layered heater 30. In one form, the substrate thickness is about ten (10) times the thickness of one of the functional layers. For example, in one form, the thin-walled substrate 22 has a thickness of about 0.2 mm and the thickness of the resistive heating layer is about 0.02 mm. The thickness of the thin-walled substrate 22 may range from about 0.2 mm to about 10 mm, and the thickness of any of the layers may range from about 0.01 mm to about 0.25 mm. Further, the thin-walled substrate 22 in one form is flexible and undergoes elastic deformation under relatively low loads, on the order of just a few (i.e., 3) pounds, or less.

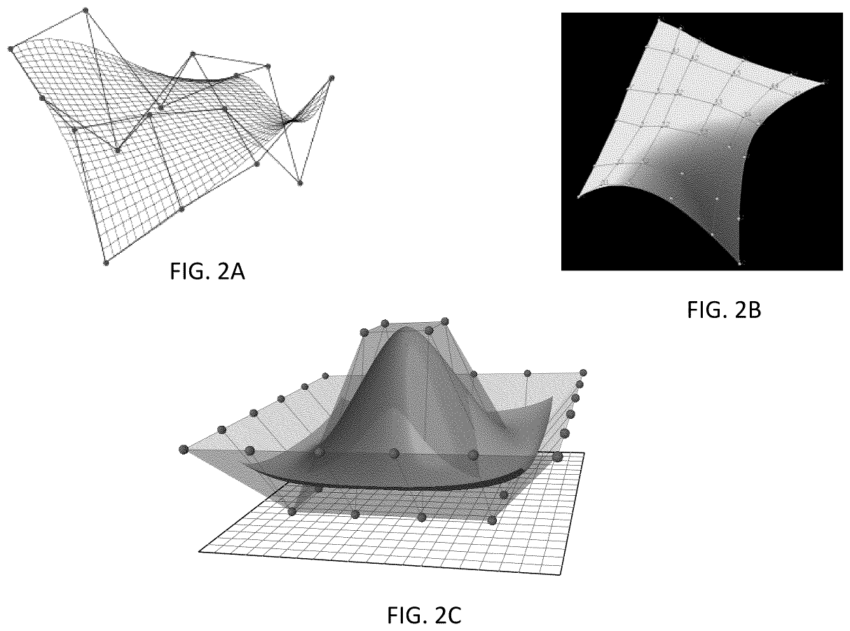

Referring to FIGS. 2A-2C, the teachings of the present disclosure are applied to substrates having a “complex curved” exterior surface. As used herein, the term “complex curved” surface should be construed to mean a surface comprised of mathematical splines, such as by way of example Bézier surfaces (FIG. 2A), B-spline surfaces (FIG. 2B), or non-uniform rational basis (NURB) surfaces (FIG. 2C), among others. Applying heat to these complex curved surfaces is often challenging due to the multiple changes in surface profile compared with the geometry of other substrates, such as flat or cylindrical substrates. It should be understood that the complex curved surfaces shown are for illustration purposes only and should not be construed as limiting the scope of the present disclosure.

Advantageously, the present disclosure provides a unique, monolithic heated 3D body 20 that provides temperature uniformity and heat distribution at higher operating temperatures (e.g., greater than about 250° C.), in addition to excellent heat transfer capabilities without the need to modify the thin-walled substrate 22 (e.g., increase wall thickness, provide surface features such as a trench to attach a separate heater, among others) to enable Joule or resistive heating. The following examples are provided to illustrate various constructions for the monolithic heated 3D body 20 using different layer configurations, materials, and heating capabilities. These different variations are exemplary and should not be construed as limiting the scope of the present disclosure.

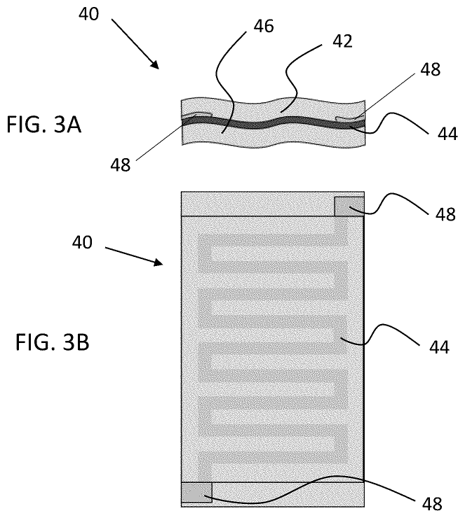

Referring to FIGS. 3A and 3B, one form of a layered heater applied to the complex curved exterior surface 24 of the thin-walled substrate 22 (FIG. 1) is illustrated and generally indicated by reference numeral 40. In this variation, the layered heater 40 comprises a base dielectric layer 42, at least one resistive heating layer 44 applied onto the base dielectric layer 42, and an outer dielectric layer 46 disposed over the resistive heating layer 44. A set of termination pads 48 are electrical contact with the resistive heating layer 44 as shown. The termination pads 48 are configured for connection to a power supply (not shown) to provide power to the resistive heating layer 44. The outer dielectric layer 46 provides electrical and thermal isolation of the resistive heating layer 44 to the outside environment, but the termination pads 48 remain exposed through the outer dielectric layer 46 for connection to lead wires (not shown) of the power supply. Once the lead wires are connected to the termination pads 48, an area over the termination pads 48 is subsequently covered with an electrically insulating material for electrical protection.

The resistive heating layer 44 in this form defines a trace (or pattern) that extends from one termination pad 48 to the other termination pad 48 (FIG. 3B). The length to width ratio of the trace in this example is greater than about three (3). The trace may be formed by using a mask or a direct write/printing method (e.g., thick film), or the trace may be formed by a removal technique such as laser removal after a continuous resistive heating layer has been applied. Further details regarding these methods are disclosed in U.S. Pat. Nos. 9,029,742 and 5,973,296, which are commonly owned with the present application and the contents of which are incorporated herein by reference in their entirety. Current thus flows through the trace to provide heat to the thin-walled substrate 22. In this example, the base dielectric layer 42 and the outer dielectric layer 46 are both a material having an electrical resistivity greater than about 10¹⁰ ohms, such as by way of example alumina (Al₂O₃) or other oxide and nitride ceramics. The resistive heating layer 44 is a material having an electrical resistivity between about 0.5 to about 5.0 ohm·mm²/m and a positive temperature coefficient of resistance (TCR). The termination pads 48 are a material having an electrical resistivity less than about 0.5 ohm·mm²/m.

It should be understood that the resistive heating layer 44 may be applied directly to the complex curved exterior surface 24 of the thin-walled substrate 22, thereby omitting the base dielectric layer 42, depending on the material of the thin-walled substrate 22. Further, a plurality of resistive heating layers 44 may be employed, each separated by dielectric layers, while remaining within the scope of the present disclosure. The resistive heating layer(s) 44 may also be configured in zones or in any size/shape of a trace while remaining within the scope of the present disclosure. Examples of such configurations for the resistive heating layer(s) 44, in addition to other functional layers, are illustrated and described in U.S. Pat. Nos. 7,196,295, 7,132,628, and 7,629,560, which are commonly owned with the present application and the contents of which are incorporated herein by reference in their entirety.

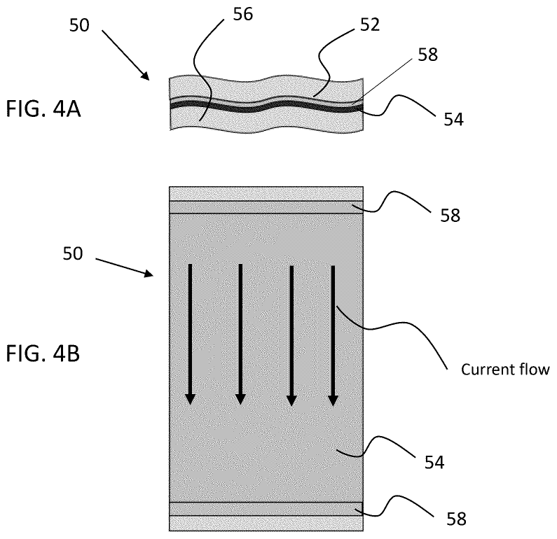

Referring now to FIGS. 4A and 4B, another form of a layered heater is illustrated and generally indicated by reference numeral 50. In this variation, the layered heater 50 comprises a base dielectric layer 52, at least one resistive heating layer 54 applied onto the base dielectric layer 52, and an outer dielectric layer 56 disposed over the resistive heating layer 54. A set of termination pads 58, which are in the form of strips, are electrical contact with the resistive heating layer 54 as shown. Each of the layers and termination pads 58 function as previously set forth, and thus they will not be described again in detail for purposes of clarity.

In this variation, the resistive heating layer 54 is continuous, or uniform across the complex curved exterior surface 24 of the thin-walled substrate 22, and does not have a pattern or trace as previously illustrated and described. Thus, the termination pads 58 are electrically across an entire width of the resistive heating layer 54, and current flows in the direction as shown. In this form, the base dielectric layer 52 and the outer dielectric layer 56 are both a material having an electrical resistivity greater than about 1010 ohms, such as by way of example alumina (Al₂O₃) or other oxide and nitride ceramics. The resistive heating layer 54 is a semiconducting material, such as by way of example titanium dioxide (TiO₂) (or TiOₓ when thermally sprayed) having an electrical resistivity greater than about 5.0 ohm·mm²/m and a negative temperature coefficient of resistance (TCR). The termination pads 58 are a material having an electrical resistivity less than about 0.5 ohm·mm²/m. And in this form, the length to width ratio of the resistive heating layer 54 is less than about three (3).

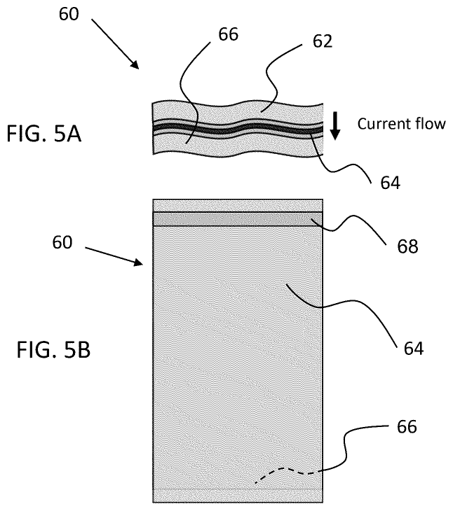

Referring to FIGS. 5A and 5B, yet another design for a layered heater is illustrated and generally indicated by reference numeral 60. In this variation, the layered heater 60 comprises a base dielectric layer 62, at least one resistive heating layer 64 applied onto the base dielectric layer 62, and an outer dielectric layer 66 disposed over the resistive heating layer 64. A set of termination pads 68, which are in the form of strips, are electrical contact with the resistive heating layer 64, but are located on opposite sides of the resistive heating layer 64 rather than on the same layer, or a common layer, as previously set forth. The resistive heating layer 64 is continuous, or uniform across the complex curved exterior surface 24 of the thin-walled substrate 22, and does not have a pattern or trace as previously illustrated and described. Therefore, current flows through the thickness of the resistive heating layer 64 as shown since one termination pad 68 is on one side of the resistive heating layer 64, and the other termination pad 68 is on the other side of the resistive heating layer 64.

In this variation, the base dielectric layer 62 and the outer dielectric layer 66 are both a material having an electrical resistivity greater than about 10¹⁰ ohms, such as by way of example alumina (Al₂O₃) or other oxide and nitride ceramics. The resistive heating layer 64 is a semiconducting material, such as by way of example titanium dioxide (TiO₂) (or TiOₓ when thermally sprayed) having an electrical resistivity greater than about 5.0 ohm·mm²/m and a negative temperature coefficient of resistance (TCR). The termination pads 68 are a material having an electrical resistivity less than about 0.5 ohm·mm²/m. And in this form, the length to width ratio of the resistive heating layer 64 is extremely low, less than about 0.1.

The substrate 22 may be any of a variety of materials and in one for is a tin (Sn) material. Other materials for the substrate 22 may be employed depending on application requirements and may include, by way of example, ceramics (e.g., Al₂O3), stainless steel, copper, or molybdenum, among others. The materials for the layered heater 30 would thus be selected accordingly for compatibility with the substrate materials. In one specific application, the materials for the layered heater 30 are selected to withstand a corrosive environment, including by way of example, tin and hydrogen. Further, the substrate 22 may be formed by any number of manufacturing methods, including by way of example, metal forming, milling, molding, and additive manufacturing, among others.

Accordingly, a lightweight, thermally efficient heater system is provided for thin-walled substrates having complex contoured surfaces. Conventional joining techniques such as mechanical attachment, bonding, and soldering, among others, are avoided. Additionally, the inventive monolithic heated 3D body reduces the amount of space required in a variety of heating applications.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A monolithic heated 3D body comprising:
a thin-walled substrate defining a complex curved exterior surface; and
a layered heater applied to the complex curved exterior surface of the thin-walled substrate, the layered heater comprising:
at least one resistive heating layer;
a set of termination pads in electrical contact with the at least one resistive heating layer; and
a dielectric layer disposed over the at least one resistive heating layer.

2. The monolithic heated 3D body according to claim 1, further comprising:
a base dielectric layer applied onto the complex curved exterior surface of the thin-walled substrate, wherein the at least one resistive heating layer is applied onto the base dielectric layer.

3. The monolithic heated 3D body according to claim 1, wherein the layered heater is formed by a layered process.

4. The monolithic heated 3D body according to claim 1, wherein the thin-walled substrate has a thickness between about 0.2mm and about 10.0 mm.

5. The monolithic heated 3D body according to claim 1, wherein the at least one resistive heating layer is continuous across the complex curved exterior surface of the thin-walled substrate.

6. The monolithic heated 3D body according to claim 1, wherein the at least one resistive heating layer is patterned across the complex curved exterior surface of the thin-walled substrate.

7. The monolithic heated 3D body according to claim 1, wherein the set of termination pads are on a common layer.

8. The monolithic heated 3D body according to claim 1, wherein the set of termination pads are on different layers.

9. The monolithic heated 3D body according to claim 1, wherein the thin-walled substrate is a tin material.

10. The monolithic heated 3D body according to claim 1, wherein the thin-walled substrate that has a thickness limited to no more than one order of magnitude thicker than each of the at least one resistive heating layer and the dielectric layer.

11. The monolithic heated 3D body according to claim 10, wherein the thickness of the thin-walled substrate is between about 0.2 mm to about 10 mm, and the thickness of each of the at least one resistive heating layer and the dielectric layer of the layered heater is between about 0.01 mm to about 0.25 mm.

12. The monolithic heated 3D body according to claim 1, wherein the complex curved exterior surface is one of a Bézier surface, a B-spline surface, or a non-uniform rational basis (NURB) surface.

13. The monolithic heated 3D body according to claim 1, wherein the layered heater is applied to the complex curved exterior surface of the thin-walled substrate with a thermal spray process.

14. The monolithic heated 3D body according to claim 13, wherein the at least one resistive heating layer is patterned using a laser removal process.

15. The monolithic heated 3D body according to claim 1, wherein the set of termination pads are in a form of strips.
